(19) United States
(12) Patent Application Publication
(10) Pub. No.: US 2009/0282105 A1
(43) Pub. Date: Nov. 12, 2009

(54) P2P DATA DELIVERY SYSTEM, P2P DATA DELIVERY METHOD AND P2P DATA DELIVERY PROGRAM

(75) Inventor: Satoshi Kamiya, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/312,146

(22) PCT Filed: Nov. 1, 2007
(86) PCT No.: PCT/JP2007/071349

§ 371 Date: Apr. 28, 2009

(30) Foreign Application Priority Data
Nov. 9, 2006 (JP) 2006-304481

(51) Int. Cl. G06F 15/16

(52) U.S. Cl. 709/204

(57) ABSTRACT

Since a shared public data delivery module makes a response to a data query to other data delivery modules or other shared public data delivery modules; or to a query from other data delivery modules or other shared public data delivery modules instead of the data delivery module, the data delivery module needs not to directly make response to the data query, and it is hence possible to reduce load imposed on data delivery modules participating in the P2P data delivery system. For example, for a data request issued from a data delivery module, an adjacent shared public data delivery module acquires data substitutionally; it is hence possible to reduce the transfer network amount between the module having issued the data request and other data delivery modules and between the module having issued the data request and other shared public data delivery modules not adjacent thereto.

### TECHNICAL FIELD

The present invention relates to a P2P data delivery system, a P2P data delivery method, and a P2P data delivery program, and in particular, to a P2P data delivery system, a P2P data delivery method, and a P2P data delivery program for delivering data in a Peer to Peer (to be referred to as P2P herein below) communication mode.

### RELATED ART

Recently, Napster, Gnutella, KaZaA, BitTorrent, and the like have been developed as file sharing software (data delivery software) employing the P2P technique. Also, there has been developed Voice over IP (VoIP) software such as Skype based on a P2P file sharing technique.

These file sharing software products are installed for use in respective Personal Computers (PC). The PC for operating the installed file sharing software is coupled with an unspecified number of other PCs, which operate the same file sharing software, on equal terms without any master-servant relationship, to construct a P2P file sharing system.

In the P2P file sharing system, when a PC in the system requests file data, one or more PCs delivers the requested data, resulting in realizing a delivery function (a system realizing the data delivery function by the file sharing software will be referred to as a P2P data delivery system herein below).

The invention described in Non-patent Document 1 is an example of the conventional P2P data delivery system. FIG. 1 is a conventional pure-type P2P data delivery system and FIG. 2 is a conventional hybrid-type P2P data delivery system.

The pure-type P2P data delivery system shown in FIG. 1 includes a plurality of P2P data delivery modules M1 to Mn having one and the same data delivery function. Each of the P2P data delivery modules M1 to Mn is network-connected to at least one of the other P2P data delivery modules M1 to Mn.

In the pure-type P2P data delivery system shown in FIG. 1, when the P2P data delivery module M1 issues a data request, the data request propagates to each of the P2P data delivery modules M2 to Mn and any P2P data delivery module having the pertinent data (the P2P data delivery module Mn in FIG. 1) returns a response indicating existence of the data. Thereafter, the P2P data delivery module Mn conducts data delivery to the P2P data delivery module M1. Also, there exists a case to employ a P2P protocol in which a plurality of P2P data delivery modules M2 to Mn conducts data delivery to the P2P data delivery module M1 as the data request source.

In addition, the hybrid-type P2P data delivery system shown in FIG. 2 includes P2P data delivery modules M1 to Mn and supernodes M′1 to M′n. Each of the P2P data delivery modules M1 to Mn is network-connected to either one of the supernodes M′1 to M′n to collect information of existing data. Also, the supernodes M′1 to M′n are network-connected with each other to exchange information of existing data.

In the hybrid-type P2P data delivery system shown in FIG. 2, when the P2P data delivery module M1 issues a request of a query for an address of a data delivery module possessing particular data, the query request propagates to an adjacent supernode (the supernode M′1 in FIG. 2). Then, the query request is transferred between the supernodes M′1 to M′n, and a supernode (the supernode M′n in FIG. 2) possessing the address information of the P2P data delivery modules M2 to Mn possessing the pertinent data returns the address information of the pertinent P2P data delivery module Mn to the P2P data delivery module M1. Thereafter, the P2P data delivery module M1 issues a data transmission request to the P2P data delivery module Mn, and the P2P data delivery module Mn conducts data delivery to the P2P data delivery module M1. Additionally, there also exists a case to use a P2P protocol in which a plurality of P2P data delivery modules M2 to Mn conducts data delivery to the P2P data delivery module M1 as the data request source.

Patent Document 1 proposes a P2P network superior in security in which the data communication is not directly conducted between user terminals, but agents communicate data stored in storages, and hence IP addresses or the like of the user terminals are not opened to the other users.

Patent Document 2 discloses a peer-to-peer content delivery system wherein a cache unit is disposed between a content requesting peer and a content possessing peer; in response to a content acquisition request from the content requesting peer to the content possessing peer, the cache unit returns a content acquisition response signal instead of the content possessing peer if cache data of the specified content has been stored in a cache storage to reduce the period of time required for the content acquisition; and any content beforehand stored in the cache storage can be acquired regardless of the connection state of the content possessing peer.

Patent Document 3 proposes an information processing apparatus wherein when a peer having a wait function issues a request for transmission of various information pieces to other peers which have a transfer function and which are beforehand set to setting information stored in the own peer or to the other peers by a multicast or a broadcast and receives some information from other peers, the peer stores the information in a P2P-based control data storage; at reception of a request message from an end peer, the peer sends information associated with the request message to the request source peer and further transfers the request message to an adjacent peer; and the peer receives a response message sent from a peer which can respond to the request message and sends the response message to the end peer.

Patent Document 4 proposes a network system wherein a node possessing a content generates meta-information of the content to deliver the generated meta-information to a main node; at reception of the meta-information from the node, the main node updates the storage location of the content contained in the meta-information; at acquiring of a content, a PC accesses a server to acquire meta-information of the desired content by use of a directory service and accesses a main node based on the meta-information to thereby facilitate information exchange between different networks.

Patent Document 5 proposes a P2P network system wherein each index server includes means for receiving a retrieval query from a client to return a retrieval result; means for issuing a query, if the server does not respond to a cache corresponding to the received retrieval query, to other servers to determine whether or not the servers respond to the cache; means for issuing, if a retrieval query received as a result of the query is a first retrieval query, a single-item retrieval request associated with the retrieval query and selecting, according to a result of the retrieval, a server which responds to the cache corresponding to the retrieval query; and means for transmitting, to the client, information of the server which responds to the cache.

### Patent Document 1: Japanese Patent Laid-Open Publication No. 2003-186777

### Patent Document 2: Japanese Patent Laid-Open Publication No. 2004-246786

### Patent Document 3: Japanese Patent Laid-Open Publication No. 2006-178749

### Patent Document 4: Japanese Patent Laid-Open Publication No. 2006-190205

### Patent Document 5: Japanese Patent Laid-Open Publication No. 2006-195533

### Non-patent Document 1: Nikkei COMPUTER, Jun. 12, 2006; pp. 162-167

### DISCLOSURE OF THE INVENTION

### Problem to be Solved by the Invention

However, the inventions described above contain problems as below.

In the conventional P2P data delivery system, processing load increases in the data delivery modules participating in the P2P data delivery system. That is, when the user makes his or her own module participate in the P2P data delivery system, access continuously occurs from external devices to the own module and hence the load increases.

Furthermore, in the conventional P2P data delivery system, the amount of used network bandwidths between the data delivery modules participating in the P2P data delivery system and the data delivery system increases. In other words, when the user makes his or her own module participate in the P2P data delivery system, access continuously occurs from external devices to the own module and hence the network traffic increases between the own module and the data delivery system.

Additionally, in the conventional P2P data delivery system, a threat of illegal access to the data delivery modules participating in the P2P data delivery system increases. That is, when the user makes his or her own module participate in the P2P data delivery system, the own module becomes the data delivery module. In the situation, an unspecified number of users of the associated P2P data delivery system accesses to file data existing in the own module. As a result, since the users possibly include a malicious user, the threat of illegal access to the own module increases.

It is therefore an exemplary object of the present invention to provide a P2P data delivery system, a P2P data delivery method, and a P2P data delivery program in which since a shared public data delivery module adjacent to a data delivery module makes a response to a data query to other data delivery modules or other shared public data delivery modules or a query from other data delivery modules or other shared public data delivery modules instead of the data delivery module, the data delivery module needs not to directly make response to the data query, and it is hence possible to reduce load imposed on data delivery modules participating in the P2P data delivery system.

Also, an exemplary object of he present invention is to provide a P2P data delivery system, a P2P data delivery method, and a P2P data delivery program in which a shared public data delivery module conducts substitutionally not only a data query, a data request, and an data acquisition issued from a data delivery module adjacent to the shared public data delivery module, but also conducts substitutionally data query, a data request, and a data acquisition issued from other shared public data delivery modules; and hence data to be cached between the shared public data delivery modules is uniformalized; any data delivery module participating in the system from any place needs not to acquire data from any other data delivery module if the data is possessed by shared public data delivery modules, but the data can be acquired from an adjacent shared public data delivery module; it is hence possible to improve the data delivery speed.

Additionally, an exemplary object of the present invention is to provide a P2P data delivery system, a data delivery method, and a data delivery program in which at reception of participation of a data delivery module in the P2P data delivery system, authentication processing is executed for the data delivery module to grant participation in the system only for the data delivery module successfully authenticated, and hence users participating in the P2P data delivery system can be correctly identified; even if a malicious user attempts to participate in the P2P data delivery system, participation is not granted if the user is not identified; it is hence possible to beforehand prevent unauthorized access.

### Means for Solving the Problem

A first exemplary aspect of the present invention is a P2P data delivery system including: a plurality of data delivery units and a plurality of shared public data delivery modules for storing therein data of the data delivery units, wherein each of the shared public data delivery modules issues, at reception of a data query for data from one of the data delivery units, a query, substituting for the data delivery unit, to other shared public data delivery modules for presence or absence of the data; notifies, at reception of a reply of possession of the data from one of the other shared public data delivery modules, the condition to the data delivery unit; and acquires, when the data delivery unit issues a request of acquisition of the data from the other one shared public data delivery module, the data, substituting for the data delivery unit from the other one shared public data delivery module and delivers the data to the data delivery unit.

A second exemplary aspect of the present invention is a P2P data delivery system in accordance with the first exemplary aspect, wherein each one of the other shared public data delivery modules judges, at reception of the data query from the shared public data delivery module, whether or not the data has been stored; and transmits as a response, if the data has been stored, possession of the data and identifier information unique to the own module to the shared public data delivery module; the shared public data delivery module notifies, at reception of the response from the other one shared public data delivery module, the possession of the data and the identifier information to the data delivery unit; and the data delivery unit requests, based on the identifier information, acquisition of the data to the shared public data delivery module.

A third exemplary aspect of the present invention is a P2P data delivery system in accordance with the second exemplary aspect, wherein the shared public data delivery module issues, when the data delivery unit requests the acquisition of data based on the identifier information, a request for the data to the other one shared public data delivery module substituting for the data delivery unit based on the identifier information.

A fourth exemplary aspect of the present invention is a P2P data delivery system in accordance with one of the first to the third exemplary aspects, wherein the shared public data delivery module stores, when the data is acquired from the other one shared public data delivery module, the data in its own module.

A fifth exemplary aspect of the present invention is a P2P data delivery system in accordance with one of the first to the fourth exemplary aspects, wherein the shared public data delivery module judges, at reception of a data query of data from the data delivery unit, whether or not the data has been stored in its own module; notifies possession of the data to the data delivery unit without issuing a query to the other shared public data delivery modules if it is judged that the data has been stored in its own module; and delivers the data to the data delivery unit, if the data delivery unit issues a request of acquisition of the data.

A sixth exemplary aspect of the present invention is a P2P data delivery system in accordance with one of the first to the fifth exemplary aspects, wherein the data delivery unit requests the shared public data delivery module for participation in the P2P data delivery system by use of a beforehand assigned ID and a beforehand assigned password; and the shared public data delivery module judges whether or not the ID and the password received from the data delivery unit match a beforehand stored ID and a beforehand stored password; and grants participation of the data delivery unit in the P2P data delivery system if the ID and the password match the beforehand stored ID and the beforehand stored password.

A seventh exemplary aspect of the present invention is a P2P data delivery system in accordance with the sixth exemplary aspect, wherein the data delivery unit granted for participation in the P2P data delivery system can register data, which is to be opened to the system, to the shared public data delivery module.

An eighth exemplary aspect of the present invention is a P2P data delivery method for use with a P2P data delivery system including a plurality of data delivery units and a plurality of shared public data delivery modules for storing therein data of the data delivery units, wherein each one of the shared public data delivery modules includes a step of issuing, at reception of a data query for data from one of the data delivery units, a query, substituting for the data delivery unit, to other shared public data delivery modules for presence or absence of the data; a step of notifying, at reception of a reply of possession of the data from one of the other shared public data delivery modules, the condition to the data delivery unit; and a step of acquiring, when the data delivery unit issues a request of acquisition of the data from the other one shared public data delivery module, the data, substituting for the data delivery unit, from the other one shared public data delivery module and delivering the data to the data delivery unit.

A ninth exemplary aspect of the present invention is a P2P data delivery method in accordance with the eighth exemplary aspect, wherein each one of the other shared public data delivery modules includes a step of judging, at reception of the data query from the shared public data delivery module, whether or not the data has been stored; and a step of transmitting as a response, if the data has been stored, possession of the data and identifier information unique to the own module to the shared public data delivery module; the shared public data delivery module includes a step of notifying, at reception of the response from the other one shared public data delivery module, the possession of the data and the identifier information to the data delivery unit; and the data delivery unit includes a step of requesting, based on the identifier information, acquisition of the data to the shared public data delivery module.

A 10th exemplary aspect of the present invention is a P2P data delivery method in accordance with the ninth exemplary aspect, wherein the shared public data delivery module includes a step of issuing, when the data delivery unit requests the acquisition of data based on the identifier information, a request for the data to the other one shared public data delivery module substituting for the data delivery unit based on the identifier information.

An 11th exemplary aspect of the present invention is a P2P data delivery method in accordance with one of the eighth to the 10th exemplary aspects, wherein the shared public data delivery module includes a step of storing, when the data is acquired from the other one shared public data delivery module, the data in its own module.

A 12th exemplary aspect of the present invention is a P2P data delivery method in accordance with one of the eighth to the 11th exemplary aspects, wherein the shared public data delivery module includes a step of judging, at reception of a data query of data from the data delivery unit, whether or not the data has been stored in its own module; a step of notifying possession of the data to the data delivery unit without issuing a query to the other shared public data delivery modules if it is judged that the data has been stored in its own module; and a step of delivering the data to the data delivery unit, if the data delivery unit issues a request of acquisition of the data.

A 13th exemplary aspect of the present invention is a P2P data delivery method in accordance with one of the eighth to the 12th exemplary aspects, wherein the data delivery unit includes a step of requesting the shared public data delivery module for participation in the P2P data delivery system by use of a beforehand assigned ID and a beforehand assigned password; and the shared public data delivery module includes a step of judging whether or not the ID and the password received from the data delivery unit match a beforehand stored ID and a beforehand stored password; and a step of granting participation of the data delivery unit in the P2P data delivery system if the ID and the password match the beforehand stored ID and the beforehand stored password.

A 14th exemplary aspect of the present invention is a P2P data delivery method in accordance with the 13th exemplary aspect, wherein the data delivery unit granted for participation in the P2P data delivery system can register data, which is to be opened to the system, to the shared public data delivery module.

A 15th exemplary aspect of the present invention is a P2P data delivery program for use with a P2P data delivery system including a plurality of data delivery units and a plurality of shared public data delivery modules for storing therein data of the data delivery units, wherein each of the shared public data delivery modules includes processing for issuing, at reception of a data query for data from one of the data delivery units, a query, substituting for the data delivery unit, to other shared public data delivery modules for presence or absence of the data; processing for notifying, at reception of a reply of possession of the data from one of the other shared public data delivery modules, the condition to the data delivery unit; and processing for acquiring, when the data delivery unit issues a request of acquisition of the data from the other one shared public data delivery module, the data, substituting for the data delivery unit, from the other one shared public data delivery module and delivering the data to the data delivery unit.

A 16th exemplary aspect of the present invention is a P2P data delivery program in accordance with the 15th exemplary aspect, wherein each one of the other shared public data delivery modules includes processing for judging, at reception of the data query from the shared public data delivery module, whether or not the data has been stored; and processing for transmitting as a response, if the data has been stored, possession of the data and identifier information unique to the own module to the shared public data delivery module; the shared public data delivery module includes processing for notifying, at reception of the response from the other one shared public data delivery module, the possession of the data and the identifier information to the data delivery unit; and the data delivery unit includes processing for requesting, based on the identifier information, acquisition of the data to the shared public data delivery module.

A 17th exemplary aspect of the present invention is a P2P data delivery program in accordance with the 16th exemplary aspect, wherein the shared public data delivery module includes processing for issuing, when the data delivery unit requests the acquisition of data based on the identifier information, a request for the data to the other one shared public data delivery module substituting for the data delivery unit based on the identifier information.

An 18th exemplary aspect of the present invention is a P2P data delivery program in accordance with one of the 15th to the 17th exemplary aspects, wherein the shared public data delivery module includes processing for storing, when the data is acquired from the other one shared public data delivery module, the data in its own module.

A 19th exemplary aspect of the present invention is a P2P data delivery program in accordance with one of the 15th to the 18th exemplary aspects, wherein the shared public data delivery module includes processing for judging, at reception of a data query of data from the data delivery unit, whether or not the data has been stored in its own module; processing for notifying possession of the data to the data delivery unit without issuing a query to the other shared public data delivery modules if it is judged that the data has been stored in its own module; and processing for delivering the data to the data delivery unit, if the data delivery unit issues a request of acquisition of the data.

A 20th exemplary aspect of the present invention is a P2P data delivery program in accordance with one of the 15th to the 19th exemplary aspects, wherein the data delivery unit includes processing for requesting the shared public data delivery module for participation in the P2P data delivery system by use of a beforehand assigned ID and a beforehand assigned password; and the shared public data delivery module includes processing for judging whether or not the ID and the password received from the data delivery unit match a beforehand stored ID and a beforehand stored password; and processing for granting participation of the data delivery unit in the P2P data delivery system if the ID and the password match the beforehand stored ID and the beforehand stored password.

A 21st exemplary aspect of the present invention is a P2P data delivery program in accordance with the 20th exemplary aspect, wherein the data delivery unit granted for participation in the P2P data delivery system can register data, which is to be opened to the system, to the shared public data delivery module.

### ADVANTAGES OF THE INVENTION

In the present invention, since a shared public data delivery module adjacent to a data delivery module makes a response to a data query to other data delivery modules or other shared public data delivery modules or a query from other data delivery modules or other shared public data delivery modules instead of the data delivery module, the data delivery module needs not to directly make response to the data query, and it is hence possible to reduce load imposed on data delivery modules participating in the P2P data delivery system. For example, for a data request issued from a data delivery module, an adjacent shared public data delivery module acquires data substitutionally; it is hence possible to reduce the transfer network amount between the data delivery module having issued the data request and other data delivery modules and between the data delivery module having issued the data request and other shared public data delivery modules not adjacent thereto.

Additionally, in the present invention, a shared public data delivery module conducts substitutionally not only a data query, a data request, and a data acquisition issued from a data delivery module adjacent thereto, but also conducts substitutionally a data query, a data request, and a data acquisition issued from other shared public data delivery modules; and hence data to be cached between the shared public data delivery modules is uniformalized; any data delivery module participating in the system from any place needs not to acquire data from any other data delivery module if the data is possessed by shared public data delivery modules, but the data can be acquired from the adjacent shared public data delivery module; it is hence possible to improve the data delivery speed.

Moreover, in the present invention, at reception of participation of a data delivery module in the P2P data delivery system, authentication processing is executed for the data delivery module to grant participation in the system only for the data delivery module successfully authenticated, and hence users participating in the P2P data delivery system can be correctly identified; even if a malicious user attempts to participate in the P2P data delivery system, participation is not granted if the user is not identified; it is hence possible to beforehand prevent unauthorized access.

### BEST MODE FOR CARRYING OUT THE INVENTION

Next, description will be given of configuration and operation of a P2P data delivery system in accordance with an exemplary embodiment of the present invention.

First, the configuration of the P2P data delivery system according to the exemplary embodiment will be described by referring to FIG. 3.

The P2P data delivery system 1 according to the exemplary embodiment includes shared public data delivery modules A1 to An and P2P data delivery modules B1 to Bn.

Each of the shared public data delivery modules A1 to An is connected to the plural P2P data delivery modules B1 to Bn and the other shared public data delivery modules A1 to An. The connection between the shared public data delivery modules A1 to An may be of arbitrary topology. Furthermore, the P2P data delivery modules B1 to Bn may be connected to other P2P data delivery modules B1 to Bn, in addition to the shared public data delivery modules A1 to An. In this regard, a direct connection is present between the P2P data delivery modules B1 and B3 in FIG. 3. Between the P2P data delivery modules B1 and B3, there is implemented operation equal to that of the conventional P2P data delivery system.

Subsequently, description will be given of specific configuration of the shared public data delivery modules A1 to An by referring to FIG. 4.

Each of the shared public data delivery modules A1 to An in accordance with the exemplary embodiment includes a plurality of network interfaces C1 to Cn, a P2P data delivery protocol processing section 20, an authentication processing section 30, and a data storage 40.

The network interfaces C1 to Cn are interfaces to connect a network to the shared public data delivery module 2. The P2P data delivery protocol processing section 20 obtains and analyzes data flowing through the network. The authentication processing section 30 carries out authentication when each of the P2P data delivery modules B1 to Bn participates in the P2P data delivery system 1.

The P2P data delivery protocol processing section 20 executes, in response to a data request from one of the P2P data delivery modules B1 to Bn, proxy processing of the data request to the other shared public data delivery modules A1 to An. Moreover, the P2P data delivery protocol processing section 20 opens data stored in the data storage 40 to the public and delivers data in response to a data request from the P2P data delivery modules B1 to Bn and the other shared public data delivery modules.

The data storage 40 stores therein data obtained through the proxy response and public data kept in the P2P data delivery modules B1 to Bn.

Next, referring to FIGS. 5 to 8, description will be given of a specific operation of the P2P data delivery system in accordance with the exemplary embodiment.

First, referring to FIG. 5, description will be given of an authentication operation when the P2P data delivery module participates in the P2P data delivery system. Here, description will be given of a case wherein the P2P data delivery module B1 participates in the P2P data delivery system 1.

To request connection to the P2P data delivery system 1, the P2P data delivery module B1 issues a query to the adjacent shared public data delivery module A1 for authentication processing (step S301). In the operation, the P2P data delivery module B1 transmits a beforehand assigned ID and a beforehand assigned password to the shared public data delivery module A1 to request execution of the authentication processing.

At reception of a query for the authentication processing from the P2P data delivery module B1, the authentication processing section 30 of the shared public data delivery module A1 executes the authentication processing. Concretely, the authentication processing section 30 compares an ID and a password of profile information beforehand stored in the data storage 40 with the ID and the password inputted from the P2P data delivery module B1; if the IDs and the passwords of both sides match each other and there exists no user who has conducted a login using the same ID and the same password as those above at the same time, the authentication processing section 30 grants the login of the P2P data delivery module B1.

In the above processing, if the authentication is successfully completed for the P2P data delivery module B1 from which the authentication processing section 30 has received the query, the shared public data delivery module A1 returns a normal reply to the P2P data delivery module B1 (step S302). On receiving the normal reply from the shared public data delivery module A1, the P2P data delivery module B1 is in a state that the P2P data delivery module B1 is participating in the P2P data delivery system 1.

On the other hand, as a result of the authentication processing in the authentication processing section 30, if the authentication of the P2P data delivery module B1 has resulted in failure, the shared public data delivery module A1 notifies the P2P data delivery module B1 of the condition that the P2P data delivery module B1 cannot participate in the P2P data delivery system 1. In this connection, it is also possible to arrange a procedure in which when the authentication of the P2P data delivery module B1 results in failure, the P2P data delivery module B1 is additionally registered to the P2P data delivery system 1.

Next, referring to FIG. 6, description will be given of operation in which the P2P data delivery module B1 participating in the P2P data delivery system 1 registers public data to the system.

The P2P data delivery module B1 granted through the processing shown in FIG. 5 the participation in the P2P data delivery system 1 can register data, which is to be opened to the P2P data delivery system 1, to the adjacent shared public data delivery module A1 (step S401). The data storage 40 of the shared public data delivery module A1 stores the data for which registration is requested by the P2P data delivery module B1.

When the data from the P2P data delivery module B1 is stored in the data storage 40 of the shared public data delivery module A1, the P2P data delivery protocol processing section 20 of the shared public data delivery module A1 is enabled to conduct a proxy reply instead of the P2P data delivery module B1 to a data request from the other P2P data delivery modules B2 to Bn and the other shared public data delivery modules A2 to An.

Next, referring to FIG. 7, description will be given of operation in which the shared public data delivery module A1 delivers data stored in the data storage 40 in response to a data request from the P2P data delivery module B1.

First, the P2P data delivery module B1 transmits a query of obtained data to the adjacent shared public data delivery module A1 (step S501). The shared public data delivery module A1 searches the data storage 40 for the requested data. And if the requested data has been stored in the data storage 40, the shared public data delivery module A1 notifies the P2P data delivery module B1 of the condition that the requested data has been stored (step S502).

At reception of the notification that the data has been stored from the shared public data delivery module A1, the P2P data delivery module B1 sends a data request to the shared public data delivery module A1 (step S503). On receiving the data request from the P2P data delivery module B1, the shared public data delivery module A1 reads the pertinent data from the data storage 40 and delivers the data via the P2P data delivery protocol processing section 20 to the P2P data delivery module B1 (step S504).

Subsequently, by referring to FIG. 8, description will be given of operation wherein in response to a data request from the P2P data delivery module B1, the shared public data delivery module A1 issues the data request substitutionally to the other shared public data delivery modules A2 to An and the other P2P data delivery modules B2 to Bn.

First, the P2P data delivery module B1 sends a data query to the adjacent shared public data delivery module A1 (step S601). The shared public data delivery module A1 searches the data storage 40 for the requested data. And if the requested data has not been stored in the data storage 40, the P2P data delivery protocol processing section 20 of the shared public data delivery module A1 issues substitutionally the data query from the P2P data delivery module B1 to the other shared public data delivery modules A2 to An and the other P2P data delivery modules B2 to Bn (step S602). Incidentally, in FIG. 3, since the shared public data delivery module A1 is also adjacent to the delivery module B2 in addition to the P2P data delivery module A1, the P2P data delivery protocol 20 issues the query also to the P2P data delivery module B2. Therefore, for example, if the shared public data delivery module A1 is adjacent only to the P2P data delivery module B1 and is not adjacent to the other P2P data delivery modules B2 to Bn, the P2P data delivery protocol processing section 20 issues the query only to the shared public data delivery modules A2 to An.

Each of the shared public data delivery modules A2 to An having received the query searches the data storage 40 of its own module for the requested data. Also, the P2P data delivery module B2 confirms whether or not the requested data has been stored therein. And if the requested data is detected in the storage 40, the shared public data delivery module (A2 to An) returns to the shared public data delivery module A1 a response indicating possession of the data and information unique to the own module (to be referred to as identifier information herein below; step S603). Also, if the requested data is possessed, the P2P data delivery module B2 makes a check to determine whether or not the data is data which may be opened to the P2P data delivery system 1. Only if the data is data which may be opened, the P2P data delivery module B2 returns to the shared public data delivery module A1 a response indicating possession of the data and identifier information (step S603).

At receipt of the response indicating possession of the data and the identifier information from at least one module selected from the shared public data delivery modules A2 to An and the P2P data delivery module B2, the shared public data delivery module A1 notifies the response indicating possession of the data and the identifier information to the P2P data delivery module B1 (step S604). Based on the notified identifier information, the P2P data delivery module B1 sends a data request to the adjacent shared public data delivery module A1 (step S605). In this connection, if a plurality of identifier information pieces are notified in step S604, the P2P data delivery module B1 issues a data request to the shared public data delivery module A on the basis of one of the identifier information pieces.

When the data request is received from the P2P data delivery module B1, the P2P data delivery protocol processing section 20 of the shared public data delivery module A1 issues a data request to the shared public data delivery modules A2 to An and the P2P data delivery modules B2 to Bn based on the identifier information piece received along with the data request from the P2P data delivery module B1 (step S606).

Each of the shared public data delivery modules A2 to An having received the data request reads the pertinent data from the data storage 40 and delivers the data to the shared public data delivery module A1 (step S607). Also, the P2P data delivery module B2 having received the data request conducts delivery of data to the shared public data delivery module A1 in response to the data request (step S607).

When data thus delivered is received from at least one of the shared public data delivery modules A2 to An and the P2P data delivery module B2, the shared public data delivery module A1 stores the received data in the data storage 40 (step S608). Furthermore, the shared public data delivery module A1 delivers the received data via the P2P data delivery protocol processing section 20 to the P2P data delivery module B1 (step S609).

In this regard, the data stored in the data storage 40 of the shared public data delivery module A1 is thereafter supplied in case of a data request from the shared public data delivery modules A2 to An and the P2P data delivery modules B1 to Bn.

This application is based upon and claims the benefit of priority from Japanese patent application No. 2006-304481, filed on Nov. 9, 2006, the disclosure of which is incorporated herein in its entirety by reference.

### INDUSTRIAL APPLICABILITY

In accordance with the present invention, the present invention is applicable to uses of data delivery via a network.

### BRIEF DESCRIPTION OF DRAWINGS

FIG. 1 is a diagram showing a system configuration of a conventional pure-type P2P data delivery system;

FIG. 2 is a diagram showing a system configuration of a conventional hybrid-type P2P data delivery system;

FIG. 3 is a diagram showing a system configuration of a P2P data delivery system 1 in accordance with an exemplary embodiment of the present invention;

FIG. 4 is a block diagram showing structure of the shared public data delivery modules A1 to An;

FIG. 5 is a sequence chart showing an authentication processing operation to the P2P data delivery system in accordance with the exemplary embodiment;

FIG. 6 is a sequence chart showing a data registration operation to the shared public data delivery module of the P2P data delivery system in accordance with the exemplary embodiment;

FIG. 7 is a sequence chart showing a data query operation to the shared public data delivery module of the P2P data delivery system in accordance with the exemplary embodiment; and

FIG. 8 is a sequence chart showing a data query operation from the shared public data delivery module of the P2P data delivery system in accordance with the exemplary embodiment to other shared public data delivery modules and other data delivery modules.

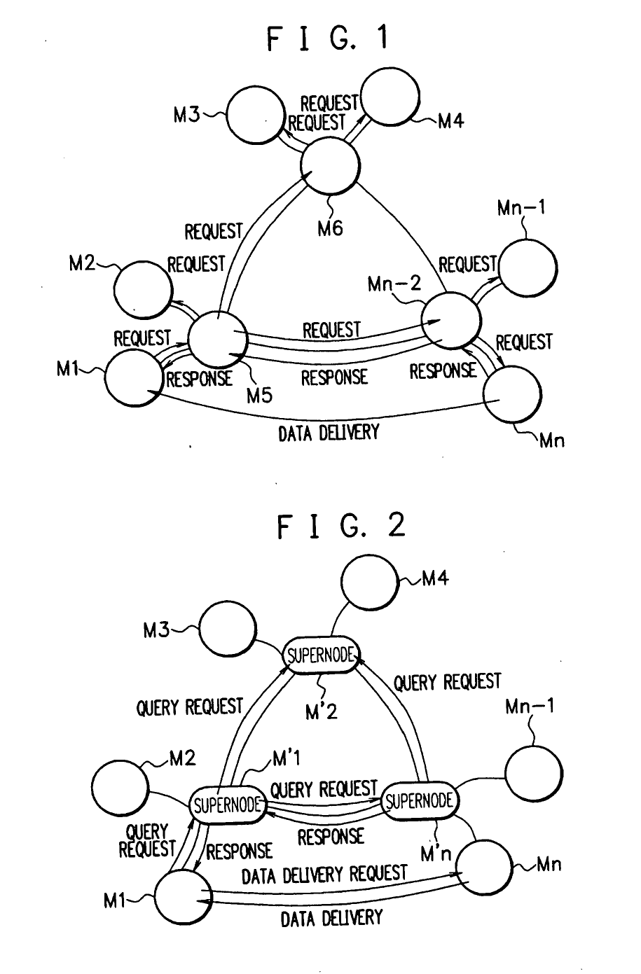

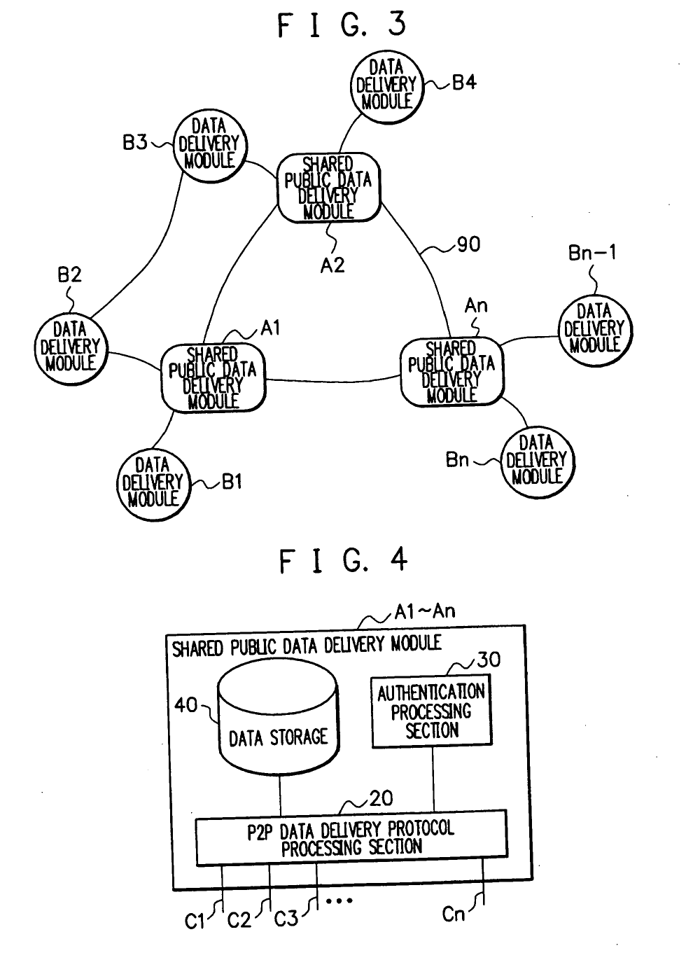

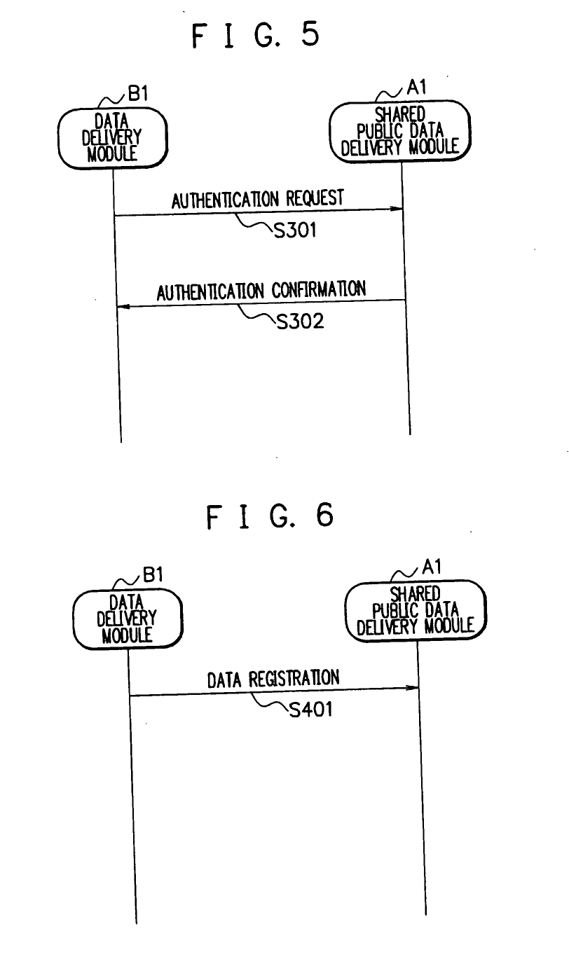

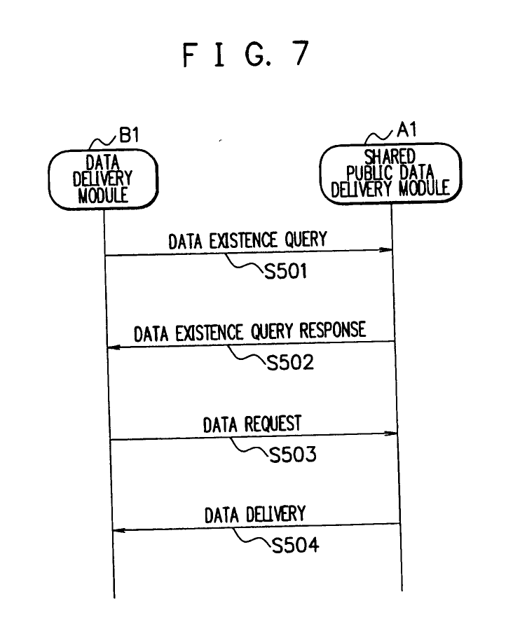

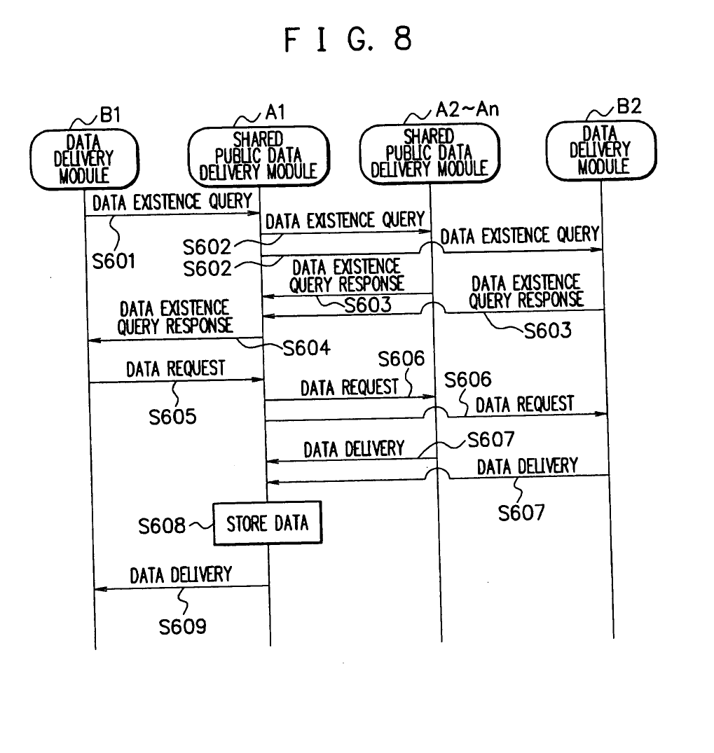

### DESCRIPTION OF REFERENCE NUMERALS

1 P2P data delivery system
A1-An Shared public data delivery module
B1-Bn Data delivery module
C1-Cn Network interface
20 P2P data delivery protocol processing section
30 Authentication processing section
40 Data storage
70 Conventional pure-type P2P data delivery system
80 Conventional hybrid-type P2P data delivery system
90 Communication connection

1. A P2P data delivery system comprising:
a plurality of data delivery units; and
a plurality of shared public data delivery modules for storing therein data of the data delivery units, wherein
each of the shared public data delivery modules
issues, at reception of a data query for data from one of the data delivery units, a query, substituting for the data delivery unit, to other shared public data delivery modules for presence or absence of the data;
notifies, at reception of a reply of possession of the data from one of the other shared public data delivery modules, the condition to the data delivery unit; and
acquires, when the data delivery unit issues a request of acquisition of the data from the other one shared public data delivery module, the data substituting for the data delivery unit from the other one shared public data delivery module and delivers the data to the data delivery unit.

2. The P2P data delivery system in accordance with claim 1, wherein
each one of the other shared public data delivery modules judges, at reception of the data query from the shared public data delivery module, whether or not the data has been stored; and transmits as a response, if the data has been stored, possession of the data and identifier information unique to the own module to the shared public data delivery module;
the shared public data delivery module notifies, at reception of the response from the other one shared public data delivery module, the possession of the data and the identifier information to the data delivery unit; and
the data delivery unit requests, based on the identifier information, acquisition of the data to the shared public data delivery module.

3. The P2P data delivery system in accordance with claim 2, wherein the shared public data delivery module issues, when the data delivery unit requests the acquisition of data based on the identifier information, a request for the data to the other one shared public data delivery module substituting for the data delivery unit based on the identifier information.

4. The P2P data delivery system in accordance with claim 1, wherein the shared public data delivery module stores, when the data is acquired from the other one shared public data delivery module, the data in its own module.

5. The P2P data delivery system in accordance with claim 1, wherein
the shared public data delivery module judges, at reception of a data query of data from the data delivery unit, whether or not the data has been stored in its own module;
notifies possession of the data to the data delivery unit without issuing a query to the other shared public data delivery modules if it is judged that the data has been stored in its own module; and
delivers the data to the data delivery unit, if the data delivery unit issues a request of acquisition of the data.

6. The P2P data delivery system in accordance with claim 1 wherein
the data delivery unit requests the shared public data delivery module for participation in the P2P data delivery system by use of a beforehand assigned ID and a beforehand assigned password; and
the shared public data delivery module judges whether or not the ID and the password received from the data delivery unit match a beforehand stored ID and a beforehand stored password; and grants participation of the data delivery unit in the P2P data delivery system if the ID and the password match the beforehand stored ID and the beforehand stored password.

7. The P2P data delivery system in accordance with claim 6, wherein the data delivery unit granted for participation in the P2P data delivery system can register data, which is to be opened to the system, to the shared public data delivery module.

8. A P2P data delivery method for use with a P2P data delivery system comprising a plurality of data delivery units and a plurality of shared public data delivery modules for storing therein data of the data delivery units: wherein
each one of the shared public data delivery modules comprises
a step of issuing, at reception of a data query for data from one of the data delivery units, a query, substituting for the data delivery unit, to the other shared public data delivery modules for presence or absence of the data;
a step of notifying, at reception of a reply of possession of the data from one of the other shared public data delivery modules, the condition to the data delivery unit; and
a step of acquiring, when the data delivery unit issues a request of acquisition of the data from the other one shared public data delivery module, the data, substituting for the data delivery unit, from the other one shared public data delivery module and delivering the data to the data delivery unit.

9. The P2P data delivery method in accordance with claim 8, wherein
each one of the other shared public data delivery modules comprises
a step of judging, at reception of the data query from the shared public data delivery module, whether or not the data has been stored; and
a step of transmitting as a response, if the data has been stored, possession of the data and identifier information unique to the own module to the shared public data delivery module;
the shared public data delivery module comprises
a step of notifying, at reception of the response from the other one shared public data delivery module, the possession of the data and the identifier information to the data delivery unit; and
the data delivery unit comprises
a step of requesting, based on the identifier information, acquisition of the data to the shared public data delivery module.

10. The P2P data delivery method in accordance with claim 9, wherein the shared public data delivery module comprises
a step of issuing, when the data delivery unit requests the acquisition of data based on the identifier information, a request for the data to the other one shared public data delivery module substituting for the data delivery unit based on the identifier information.

11. The P2P data delivery method in accordance with claim 8, wherein the shared public data delivery module comprises
a step of storing, when the data is acquired from the other one shared public data delivery module, the data in its own module.

12. The P2P data delivery method in accordance with claim 8, wherein
the shared public data delivery module comprises
a step of judging, at reception of a data query of data from the data delivery unit, whether or not the data has been stored in its own module;
a step of notifying possession of the data to the data delivery unit without issuing a query to the other shared public data delivery modules if it is judged that the data has been stored in its own module; and
a step of delivering the data to the data delivery unit, if the data delivery unit issues a request of acquisition of the data.

13. The P2P data delivery method in accordance with claim 8, wherein
the data delivery unit comprises
a step of requesting the shared public data delivery module for participation in the P2P data delivery system by use of a beforehand assigned ID and a beforehand assigned password; and
the shared public data delivery module comprises
a step of judging whether or not the ID and the password received from the data delivery unit match a beforehand stored ID and a beforehand stored password; and
a step of granting participation of the data delivery unit in the P2P data delivery system if the ID and the password match the beforehand stored ID and the beforehand stored password.

14. The P2P data delivery method in accordance with claim 13, wherein the data delivery unit granted for participation in the P2P data delivery system can register data, which is to be opened to the system, to the shared public data delivery module.

15. A storage medium for storing a P2P data delivery program for use with a P2P data delivery system comprising a plurality of data delivery units and a plurality of shared public data delivery modules for storing therein data of the data delivery units: wherein
each of the shared public data delivery modules comprises
processing for issuing, at reception of a data query for data from one of the data delivery units, a query, substituting for the data delivery unit, to the other shared public data delivery modules for presence or absence of the data;
processing for notifying, at reception of a reply of possession of the data from one of the other shared public data delivery modules, the condition to the data delivery unit; and
processing for acquiring, when the data delivery unit issues a request of acquisition of the data from the other one shared public data delivery module, the data, substituting for the data delivery unit, from the other one shared public data delivery module and delivering the data to the data delivery unit.

16. The storage medium for storing the P2P data delivery program in accordance with claim 15, wherein
each one of the other shared public data delivery modules comprises
processing for judging, at reception of the data query from the shared public data delivery module, whether or not the data has been stored; and
processing for transmitting as a response, if the data has been stored, possession of the data and identifier information unique to the own module to the shared public data delivery module;
the shared public data delivery module comprises
processing for notifying, at reception of the response from the other one shared public data delivery module, the possession of the data and the identifier information to the data delivery unit; and
the data delivery unit comprises
processing for requesting, based on the identifier information, acquisition of the data to the shared public data delivery module.

17. The storage medium for storing the P2P data delivery program in accordance with claim 16, wherein the shared public data delivery module comprises
processing for issuing, when the data delivery unit requests the acquisition of data based on the identifier information, a request for the data to the other one shared public data delivery module substituting for the data delivery unit based on the identifier information.

18. The storage medium for storing the P2P data delivery program in accordance with claim 15, wherein the shared public data delivery module comprises
processing for storing, when the data is acquired from the other one shared public data delivery module, the data in its own module.

19. The storage medium for storing the P2P data delivery program in accordance with claim 15 wherein
the shared public data delivery module comprises
processing for judging, at reception of a data query of data from the data delivery unit, whether or not the data has been stored in its own module;
processing for notifying possession of the data to the data delivery unit without issuing a query to the other shared public data delivery modules if it is judged that the data has been stored in its own module; and
processing for delivering the data to the data delivery unit, if the data delivery unit issues a request of acquisition of the data.

20. The storage medium for storing the P2P data delivery program in accordance with claim 15, wherein
the data delivery unit comprises
processing for requesting the shared public data delivery module for participation in the P2P data delivery system by use of a beforehand assigned ID and a beforehand assigned password; and
the shared public data delivery module comprises
processing for judging whether or not the ID and the password received from the data delivery unit match a beforehand stored ID and a beforehand stored password; and
processing for granting participation of the data delivery unit in the P2P data delivery system if the ID and the password match the beforehand stored ID and the beforehand stored password.

21. The storage medium for storing the P2P data delivery program in accordance with claim 20, wherein the data delivery unit granted for participation in the P2P data delivery system can register data, which is to be opened to the system, to the shared public data delivery module.
